(19) United States
(12) Patent Application Publication
(10) Pub. No.: US 2003/0156073 A1
(43) Pub. Date: Aug. 21, 2003

(54) Apparatus for adjusting proximate video monitors to output substantially identical video images and corresponding methods therefor

(75) Inventor: Cornelis Maria Van Zon, Peekskill, NY (US)

Correspondence Address: PHILIPS INTELLECTUAL PROPERTY & STANDARDS, P.O. BOX 3001, BRIARCLIFF MANOR, NY, 10510, US

(73) Assignee: KONINLIJKE PHILIPS ELECTRONICS N.V.

(21) Appl. No.: 10/080,178

(22) Filed: Feb. 20, 2002

(51) Int. Cl. G09G 5/00

(52) U.S. Cl. 345/1.1

(57) ABSTRACT

A universal remote control device for adjusting N display devices generating N copies of a video image includes an analyzer that analyzes video data corresponding to a captured Nth video image with respect to predetermined video data and generates correction data, a processor that generates correction commands applicable to the selected one of the N display devices to convert the captured video image to a desired video image responsive to the video data responsive to the correction data, and a transmitter that outputs the correction commands to the selected one of the N display devices to thereby permit the video image generated by the selected one of the N display devices to approximate the desired video image, where N is a positive integer greater than 1. A corresponding method and a memory for storing computer-readable instructions for instantiating functions by which the method can be performed are also described.

### BACKGROUND OF THE INVENTION

The present invention relates generally to video displays or monitors. More specifically, the present invention relates to a universal remote control and corresponding method for adjusting adjacent video display or monitors to permit output substantially identical video images.

The color (hue, saturation), contrast and brightness settings of consumer TV sets and monitors are factory preset and can generally be adjusted by the end user while an option is provided to return to the factory settings. When comparing multiple devices side-by-side, the factory settings may however result in different perceived impressions; such simultaneous multi-device viewing occurs for instance in a store or in an airplane. Different impressions are also caused by device-specific aging of the display and its control electronics. Means for making multiple devices appear as similar as possible are generally not provided.

It should be noted that several companies manufacture (or manufactured) equipment for adjusting monitors and displays, i.e., optical color calibration, units which can automatically color correct a properly equipped monitor relative to a standard set of color temperatures for which the device was calibrated. Other companies offer a similar product for computers, which tweaks the RAMDAC lookup tables based on signals generated by a sensor used on a monitor attached to the computer. However, none of these devices or systems would view multiple monitors and compare them against each other.

U.S. Pat. No. 4,825,201 to Watanabe et al., which patent is incorporated herein by reference, discloses a system for generating correction signals for a matrix display formed from multiple panels. The system includes a correction-value determination circuit positioned in front of and apart from the display panels, which permits observation of the optical condition of the display panels so as to determine which panel in the matrix display is in need of correction. The system also includes a correction signal generator that generates a correction signal on the basis of the correction value output by the correction value determination circuit, correction circuits for each of the display panels, and a recorrection signal generator which receives the correction signal from the correction signal generator and transmits a recorrection signal to the correction circuit of one or more of the display panels.

As illustrated in FIG. 1, which depicts a matrix display device adjustment system, a matrix display includes a plurality of display units 1 regularly arranged in the vertical and horizontal directions in a plane to form a large picture image screen. Each of the display units holding a plurality of multi-color display panels 2, such as liquid crystal panels, each of which consists of picture elements, e.g., red, blue and green panels. Each display unit 1 includes a pair of adjustment devices 3 for adjusting the drive signal applied to the display panels 2 so that the total brightness of the display panels 2 can be balanced in three colors, i.e., red, blue and green. Moreover, reference numeral 12 designates an optical measuring device, which measures brightness, color tone, and other optical properties of each of the display panels 2 to provide information needed to specify the position of the display unit 1 which requires correction. The device 12 generates and outputs this measurement signal. Numeral 13 designates a correction-value determination device, which receives the measurement signal from the optical measuring device 12 and calculates the position of the display unit 1 needing correction and a corresponding correction value. The correction-value determining device also functions to generate a correction signal.

Still referring to FIG. 1, reference numeral 8 denotes a controller acting as a recorrection signal generator. The controller 8 receives, through a remote cable 9, correction signals indicative of the display unit 1 to be corrected as well as a correction signal for the display unit 1, and processes the correction signal corresponding to the correction value to generate a recorrection signal, which is transmitted to the display unit 1 needing correction through a cable 10. Reference numeral 11 designates a correction circuit, which is connected to the control panel (not shown) for each of the display units 1. The correction circuit 11 receives the recorrection signal from the controller 8 and determines whether or not the display unit 1 requires correction. If correction is required, the correction circuit transmits the recorrection signal to the control panel.

It should be noted that the optical measuring device 12 measures the brightness and the color tone of each of the display units 1 one by one. Then, the result of each measurement is supplied to the correction-value determining device 13, which in turn transmits the correction signals, i.e., the correction value and the position of the display unit 1 to be corrected, to the controller 8. The controller 8 produces and transmits a recorrection signal corresponding to the correction signal provided from the correction-value determining device 13 to the correction circuit 11 for the display unit 1 to be corrected. The recorrection signal is transmitted from the correction circuit 11 to the control panel (not shown), whereby the brightness and the color tone of the display panel 2 are corrected. The process can be repeated as many times as needed.

Referring now to FIG. 2, the correction-value determining device 13 includes an interface IF1 for the controller 8 which receives data from and transmits data to the controller 8, a second interface IF2 coupled to the optical measuring device 12, which receives data from and transmits data to the optical measuring device 12, a central processing unit CPU3 for processing the data, a first memory device ROM3 holding the processing program and a second memory device RAM3 for storing data for the running of the program. It should be noted that the correction-value determination device 13 reads measurement values concerning the brightness of each of the display units 1, which are provided by the optical measuring device 12, and calculates the correction value for each of the display units on the basis of the measurement values. It should also be noted that the correction-value determination device can be replaced by a personal computer.

While the above-described system is useful in adjusting large matrix displays, such as those employed at sports arenas, the system is not well suited for use with other display configurations. More specifically, the color (hue, saturation), contrast, and brightness settings for consumer television (TV) sets and commercial monitors are factory preset. These parameters can generally be adjusted by the end user, although an option is provided to return the TV or monitor to its original factory settings, e.g., when the user over-adjusts the display. There are many uses for multiple display devices, e.g., televisions and monitors, in a single area; simultaneous multi-device viewing often occurs in stores or on an airplane. When making a side-by-side comparison of multiple devices, it will immediately be apparent that these factory settings may result in different visual impressions. Thus, even though all of the monitors on an airplane are projecting a single video program, the viewer will receive a different visual impression from each monitor. It should be noted that these different impressions may also be caused by device-specific aging of the display and associated control electronics, rather than differences in the factory settings.

Devices that allow adjustment of multiple display devices to make the output video images appear to be as similar as possible, i.e., substantially identical, are not available.

What is needed is an apparatus which analyzes and compares images generated by N display devices producing copies of a single video image or image stream to predetermined image characteristics and generates N correction command sets, one or more of which may be empty sets, permitting the N display devices to produce N substantially identical copies of the image of image stream. What is also needed is an apparatus which captures an image from one of N display devices producing copies of a single video image or image stream, comparing the captured image to images generated by the other N−1 display devices, and generates N−1 correction command sets permitting the N display devices to produce N substantially identical copies of the image or image stream. It would be beneficial if the apparatus could be included in a universal remote control device. What is also needed are a method and corresponding software for implementing the apparatus using commonly available, low cost components.

### SUMMARY OF THE INVENTION

Based on the above and foregoing, it can be appreciated that there presently exists a need in the art for a device and corresponding method that overcome the above-described deficiencies. The present invention was motivated by a desire to overcome the drawbacks and shortcomings of the presently available technology, and thereby fulfill this need in the art.

According to one aspect, the present invention provides a method for adjusting the display of N display devices generating N respective copies of a video image, including steps for analyzing video data corresponding to a captured video image representing the video image from a selected one of the N display devices, determining correction commands applicable to the selected one of the N display devices to convert the captured video image to a desired video image responsive to the video data, and transmitting the correction commands to the selected one of the N display devices to thereby permit the video image generated by the selected one of the N display devices to approximate the desired video image. These steps can be repeated as many times a necessary to thereby generate the desired video image on all of the N display devices. Beneficially, N is a positive integer greater than 1. If desired, the method can include steps for receiving the captured video image, and converting the captured video image to the video data, which steps are performed prior to the analyzing step. Alternatively, the method can include steps for receiving video data corresponding to the captured video image, and storing the video data, which storing steps are also performed prior to the analyzing step. Preferably, the correction commands include color and contrast correction commands. Most preferably, the correction commands correspond to signals generated by a remote control device associated with the selected one of the N display devices. The present invention is particularly useful where at least one of the N display devices includes an infrared receiver that receives infrared commands from an associated remote control device; in that case, the transmitting step includes transmitting the correction commands as infrared signals.

According to another aspect, the present invention provides a method for adjusting the display of N display devices generating N respective copies of a video image, including steps for storing desired video data representing a desired video image generated by a selected one of the N display devices, and, for the remaining N−1 display devices, comparing video data corresponding to a captured video image representing the video image from a selected one of the N−1 display devices with the desired video data to thereby generate comparison data, determining correction commands applicable to the selected one of the N−1 display devices to cause the captured video image to approximate the desired video image responsive to the comparison data, and transmitting the correction commands to the selected one of the N−1 display devices to thereby permit the video image generated by the selected one of the N−1 display devices to approximate the desired video image, where N is a positive integer greater than 1.

According to a further aspect, the present invention provides an apparatus for adjusting the display of N display devices generating N respective copies of a video image, including circuitry for analyzing video data corresponding to a captured video image representing the video image from a selected one of the N display devices, circuitry for determining correction commands applicable to the selected one of the N display devices to convert the captured video image to a desired video image responsive to the video data, and circuitry for transmitting the correction commands to the selected one of the N display devices to thereby permit the video image generated by the selected one of the N display devices to approximate the desired video image, where N is a positive integer greater than 1. If desired, the analyzing, determining, and transmitting functions are performed seriatim to adjust for each of the N display devices to thereby generate a close approximation of the desired video image. It will be noted that the apparatus can include circuitry for receiving the captured video image, and circuitry for converting the captured video image to the video data. Alternatively, the apparatus may include circuitry for receiving video data corresponding to the captured video image, and circuitry for storing the video data.

According to a still further aspect, the present invention provides an apparatus for adjusting the display of N display devices generating N respective copies of a video image, which includes first circuitry for storing desired video data representing a desired video image, second circuitry for comparing video data corresponding to a captured video image representing the video image from a selected one of the N display devices with the desired video data to thereby generate comparison data, third circuitry for determining correction commands applicable to the selected one of the N display devices to cause the captured video image to approximate the desired video image responsive to the comparison data, and fourth circuitry for transmitting the correction commands to the selected one of the N display devices to thereby permit the video image generated by the selected one of the N display devices to approximate the desired video image, where N is a positive integer greater than 1. Advantageously, the apparatus can include fifth circuitry for receiving the captured video image, and sixth circuitry for converting the captured video image to the video data. Alternatively, the apparatus can include the seventh circuitry for receiving video data corresponding to the captured video image, and eight circuitry for storing the video data.

According to another aspect, the present invention provides a universal remote control device for adjusting the display of N display devices generating N respective copies of a video image, including an analyzer that analyzes video data corresponding to a captured video image representing the video image from a selected one of the N display devices with respect to predetermined video data and generates correction data, a processor that generates correction commands applicable to the selected one of the N display devices to convert the captured video image to a desired video image responsive to the video data responsive to the correction data, and a transmitter that outputs the correction commands to the selected one of the N display devices to thereby permit the video image generated by the selected one of the N display devices to approximate the desired video image, where N is a positive integer greater than 1. If desired, the device can include an input circuit, which receives the captured video image, and a converter producing the video data from the captured video image. Alternatively, the device can include an input device that receives video data corresponding to the captured video image, a memory that stores the video data.

According to yet another aspect, the present invention provides a universal remote control device for adjusting the display of N display devices generating N respective copies of a video image, including a memory that stores desired video data representing a desired video image, a comparator that compares video data corresponding to a captured video image representing the video image from a selected one of the N display devices with the desired video data to thereby generate comparison data, a converter that outputs correction commands applicable to the selected one of the N display devices to cause the captured video image to approximate the desired video image responsive to the comparison data, and a transmitter that outputs the correction commands to the selected one of the N display devices to thereby permit the video image generated by the selected one of the N display devices to approximate the desired video image, where N is a positive integer greater than 1. If desired, the device can include an input circuit, which receives the captured video image, and a converter producing the video data from the captured video image. Alternatively, the device can include an input device that receives video data corresponding to the captured video image, and a memory that stores the video data. In any event, the converter can include a lookup table.

According to a still further aspect, the present invention provides a memory storing instructions causing a processor to instantiate functions by which an apparatus, including the processor and an output device coupled to the processor, analyzes video data corresponding to a captured video image representing the video image from a selected one of N display devices, determines correction commands applicable to the selected one of the N display devices to convert the captured video image to a desired video image responsive to the video data, and transmits the correction commands to the selected one of the N display devices to thereby permit the video image generated by the selected one of the N display devices to approximate the desired video image, for each of the N display devices, where N is a positive integer greater than 1.

According to another aspect, the present invention provides a memory storing instructions causing a processor to instantiate functions by which an apparatus, including the processor and an output device coupled to the processor, stores desired video data representing a desired video image generated by a selected one of N display devices; and, for the remaining N−1 display devices, compares video data corresponding to a captured video image representing the video image from a selected one of the N−1 display devices with the desired video data to thereby generate comparison data, determines correction commands applicable to the selected one of the N−1 display devices to cause the captured video image to approximate the desired video image responsive to the comparison data, and transmits the correction commands to the selected one of the N−1 display devices to thereby permit the video image generated by the selected one of the N−1 display devices to approximate the desired video image, where N is a positive integer greater than 1.

### BRIEF DESCRIPTION OF THE DRAWINGS

These and various other features and aspects of the present invention will be readily understood with reference to the following detailed description taken in conjunction with the accompanying drawings, in which like or similar numbers are used throughout, and in which:

FIG. 1 is a high level block diagram of a display adjustment device for a large matrix display;

FIG. 2 is a high level diagram showing the inner structure of a correction-value determination circuit of the display adjustment device depicted in FIG. 1;

FIG. 3 is a high-level block diagram of a universal remote controller according to a first preferred embodiment according to the present invention;

FIGS. 4A. 4B, and 4C collectively form a flowchart illustrating a second preferred embodiment according to the present invention; and

FIGS. 5A, 5B, and 5C collectively form a flowchart illustrating a third preferred embodiment according to the present invention.

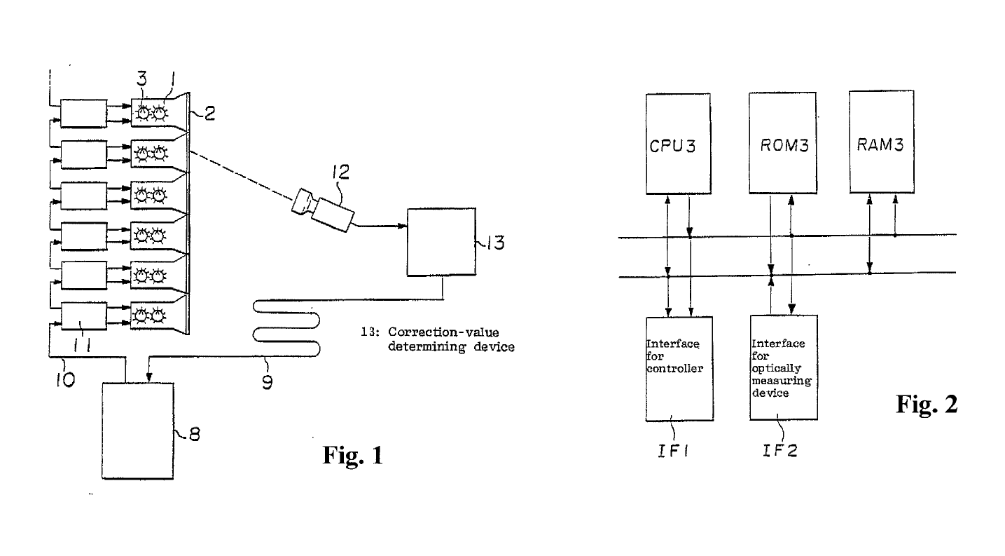

### DETAILED DESCRIPTION OF THE PREFERRED EMBODIMENTS

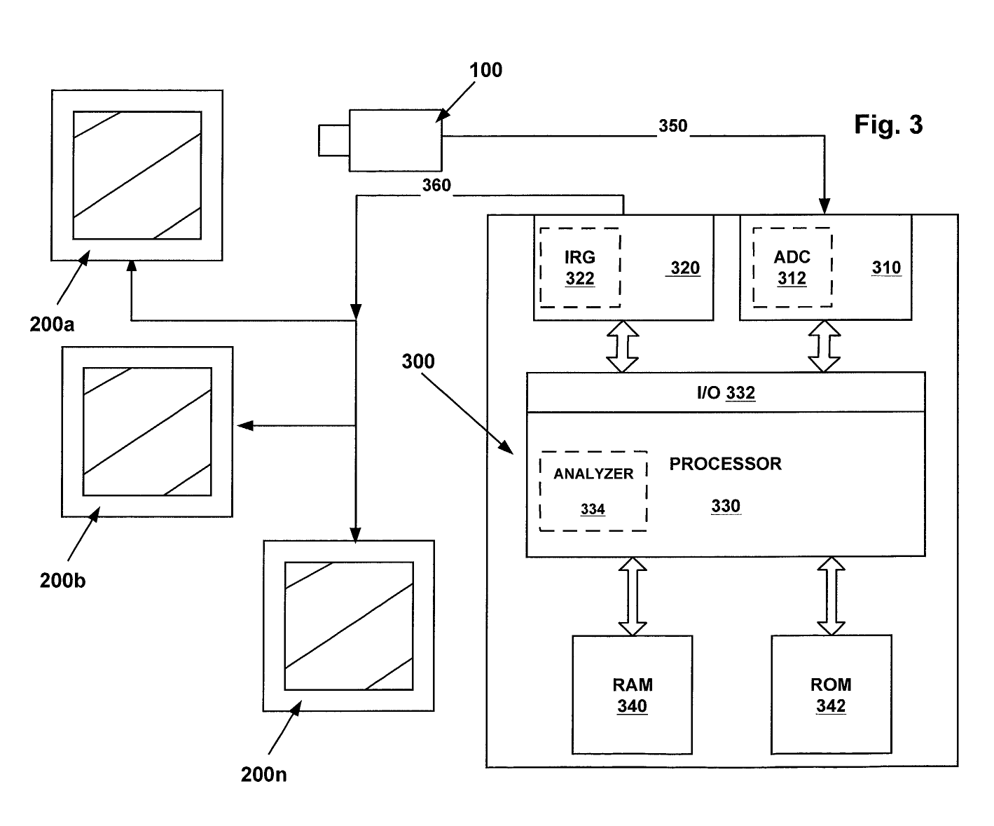

FIG. 3 is a high level block diagram of a universal remote controller according to a first preferred embodiment according to the present invention, which includes a universal remote control device 300 operatively coupled by first and second communications channels 350 and 360, respectively, to a video camera 100 and plurality of monitors 200a-200n. It will be noted that the communications channels can, not need to, be embodied in hardware, e.g., serial cables, universal serial bus (USB) cables, S-video cables, Ethernet, etc. The various devices 100, 200a-200n, and 300 advantageously can communicate among themselves via transmitted signals, e.g., infrared signals or radio frequency (RF) signals (Bluetooth, etc.). It should be noted that the present invention contemplates the situation where one of the communication channels is implemented in hardware while the other is not.

The universal remote control device 300 according to a first preferred embodiment of the present invention includes first and second input/output (I/O) ports 310 and 320, which permit signals and data generated by the camera 100 to be applied to the universal remote control device 300 and which permits correction command sets generated by the universal remote control device 300 to be output to one or more of the monitors 200a-200n. In an exemplary case, the I/O port 310 includes an analog to digital converter (ADC) 312, which converts video signals output in analog form, e.g., YUV or S-Video signals, into digital data. In the event that the camera 100 outputs digital image data, e.g., 8-bit, 15-bit, 16-bit or 24-bit graphics images, MPEG-1 or MPEG-2 images, etc., the optional ADC 312 advantageously can be omitted. Moreover, the I/O port 320 includes, in an exemplary case, and infrared generator 322, which advantageously generates infrared signals suitable of controlling the monitors 200a-200n.

Preferably, data is routed between the I/O ports 310, 320 and a processor 330 via a processor I/O device 332. The processor 330 is operatively coupled to a random access memory (RM) 340, and a read only memory (ROM) 342. The former provides temporary storage for data generated by programs and routines instantiated by the processor 330; the latter stores the programs and permanent data used by these programs. It should be mentioned at this point that the processor 330 advantageously can be one of a microprocessor or a digital signal processor (DSP); in an exemplary case, the processor 330 can include both types of processors. In another exemplary case, the processor is a DSP which instantiates an analyzer 334, which operates as discussed in greater detail below. It should also be mentioned that the ROM 140 advantageously can be a static RAM (SRAM) or electrically programmable ROM (EPROM or EEPROM), which would permit the programs and “permanent” data to be updated as new program versions become available.

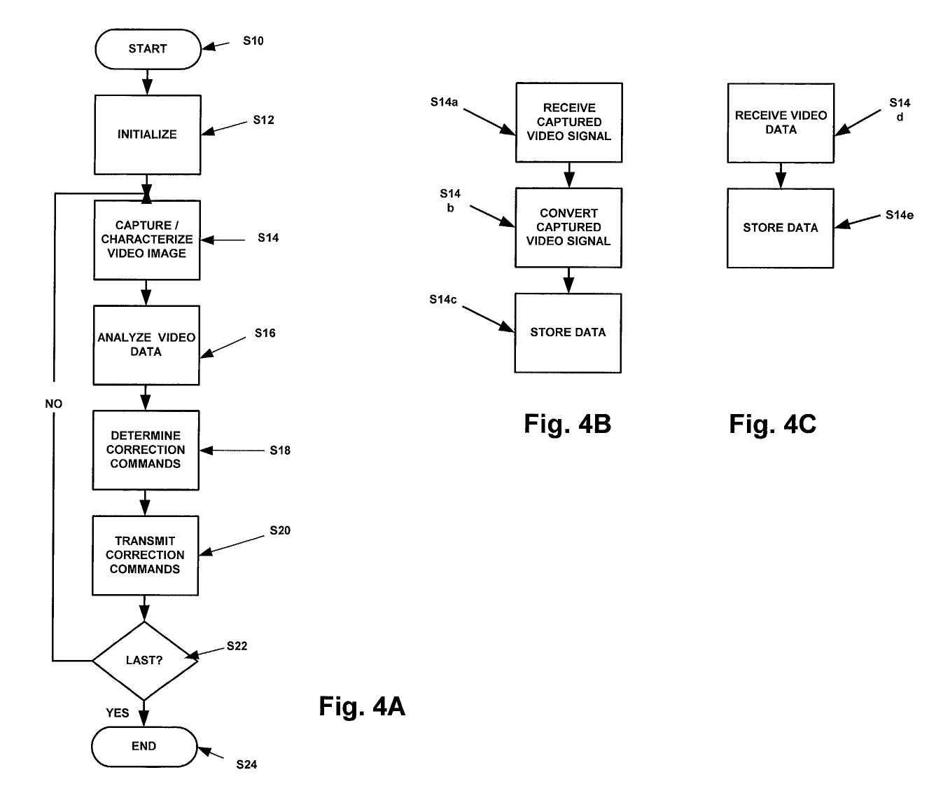

The operation of the various components illustrated in FIG. 3 will now be described with reference to FIGS. 4A, 4B, and 4C, which collectively form a detailed flowchart of an operating method according to another preferred embodiment according to the present invention. As shown in FIG. 4A, the method or routine is instantiated by the processor 330 at step S10, and is initialized during step S12. During this latter step, predetermined values and/or data employed in later steps are loaded into RAM 340.

It should be noted at this point that the preferred embodiments according to the present invention advantageously can be employed while all of the monitors 200a-200n are displaying an identical static image, the latter being generated by a video generator connected to all of the monitors. It will also be noted that it is not always practical or even feasible to connect all of the monitors to a single video source, e.g., when several TV sets operated by a restaurant are connected to a conventional antenna. In that case, the initialization routine advantageously could include subroutines for causing all of the monitors to display an image generated by an onscreen generator included in each monitor. It should also be noted that the monitor type can be determined automatically by having the universal remote control device 300 output a user-discernable command, i.e., a “display menu” command; the format of the command identifies the monitor type in an exemplary embodiment.

Still referring to FIG. 4A, during step S14, one of the N images generated by a respective one of the monitors 200a-200n is transmitted from camera 100 to the universal remote control device 300 via the first communications channel 350. It will be noted that the camera 100 is preferably located directly in front of the selected monitor at a distance where it is possible to view the entire image without viewing a significant portion of the monitor's surroundings. It will also be noted that the output of the camera 100 advantageously can be either analog or digital. In the output has an analog form, the universal remote control device 300 receives the captured video signal at the I/O port 310 during step S14a, converts the video signal to video data using the ADC 312 during step S14b, and then passes the video data to the processor 330 for processing and/or storage during step SI4c. See FIG. 4B. In the event that the output of camera 100 is digital, the I/O port 310 simply receives the captured video image in the form of video data during step S14d and then passes the video data to the processor 330 for processing and/or storage during step S14e. See FIG. 4C. The routine then steps to step S16. Thus, one of actual video data or characterization data corresponding to the video data is available to the processor 330 in the universal remote control device 300 at the completion of step S14.

During step S16, the video or characterization data corresponding to the image generated by one of the monitors 200a-200n is analyzed by the processor 330 with respect to the predetermined values stored in RAM 340. Numerous techniques are known for analyzing video data, e.g., the use of histograms, color analysis or matching, etc., and all such techniques are considered to be within the scope of the present invention. It will be appreciated that processor generates data, e.g., analysis or comparison data, at the completion of step S16. Subsequently, the routine determines a monitor specific set of correction commands, e.g., commands for correcting the hue, color saturation, brightness, contrast, etc., from the analysis data during step S18. In an exemplary case, the analysis data is employed as index data into a lookup table (LUT) stored in one of RAM 340 or ROM 342 that stores multiple correction commands addressing routinely encountered adjustment situations. Preferably, the LUT stores correction commands for a plurality of monitor types; in that case, both the analysis data and monitor type data advantageously would be employed in indexing the LUT, i.e., retrieving correction commands from the LUT. During step S20, the correction commands are transmitted to one of the monitors 200a-200n.

A check is then performed to determine whether all of the N monitors have been corrected so that all of the monitors 200a-200n generate visually similar images, i.e., the user's eyes are not drawn to a particular one of the monitors 200a-200n, at step S22. In the determination is negative, the routine jumps to the start of step S14. If the determination is affirmative, the routine ends at step S24.

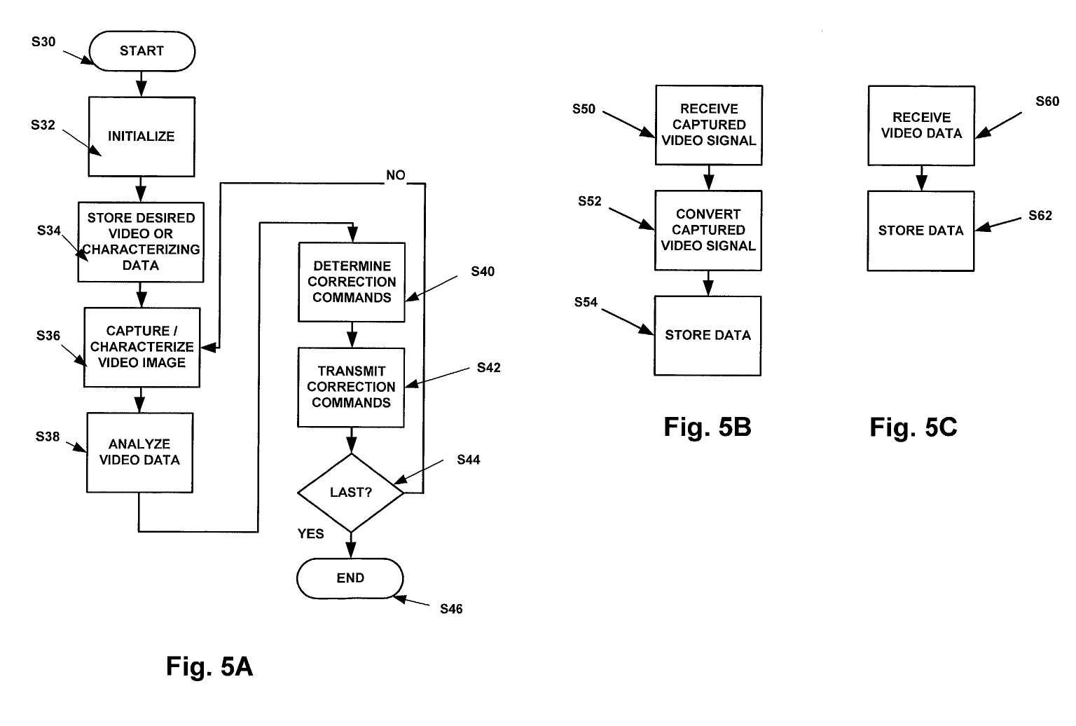

FIGS. 5A, 5B, and 5C illustrate still another preferred embodiment according to the present invention. However, in the method illustrated in the latter Figures, the universal remote control device 300 advantageously employs one of the images produced by the monitors 200a-200n as the base line and adjusts or corrects the output of the remaining N−1 monitors to that baseline.

More specifically, as shown in FIG. 5A, the method or routine is instantiated by the processor 330 at step S30, and is initialized during step S32, which could include subroutines for causing all of the monitors to display an image generated by an onscreen generator included in each monitor. During step S34, an Nth one of the images generated by the monitors 200a-200n is selected as a desired, i.e., base line, video image and either the Nth image is acquired and stored or the Nth image is characterized and the resultant characterization data is stored in the universal remote control device 300. It will be appreciated that the steps for storing the Nth image or Nth image characterization data may include receiving the captured video signal at the I/O port 310 during step S50, converting the video signal to video data using the ADC 312 during step S52, and then passing the video data to the processor 330 for analysis and/or storage during step S54, when the output of camera 100 is an analog signal. See FIG. 5B. In the event that the output of camera 100 is digital, the I/O port 310 simply receives the captured video image in the form of video data during step S60 and then passes the video data to the processor 330 for analysis and/or storage during step S62. See FIG. 5C. In short, either the Nth image or the characterization of the Nth image is available to the processor 330 in the universal remote control device 300 at the completion of step S34.

During step S36, one of the N−1 images generated by a respective one of the monitors 200a-200n−1 is transmitted from camera 100 to the universal remote control device 300 via the first communications channel 350. It will be noted that the output of the camera 100 advantageously can be either analog or digital; thus, one of the routines described above with respect to FIGS. 5B and 5C advantageously can be employed in storing and/or analyzing the N−1 images. The routine then steps to step S38.

During step S38, the video or characterization data corresponding to the image generated by one of the monitors 200a-200n is analyzed or compared by the processor 300 with respect to the actual or characterization data corresponding to the Nth video image. Again, as discussed above, it will be appreciated that there are numerous known techniques for analyzing video data, e.g., the use of histograms, color analysis or matching, etc., and all such techniques are considered to be within the scope of the present invention. It will also be appreciated that processor generates data, e.g., analysis or comparison data, at the completion of step S38. Subsequently, the routine determines a monitor specific set of correction commands, e.g., commands for correcting the hue, color saturation, brightness, contrast, etc., from the analysis data during step S40. In an exemplary case, the analysis data is employed as index data into a lookup table (LUT) stored in one of RAM 340 or ROM 342 that stores multiple correction commands addressing routinely encountered adjustment situations. Preferably, the LUT stores correction commands for a plurality of monitor types; in that case, both the analysis data and monitor type data advantageously would be employed in indexing the LUT, i.e., retrieving correction commands from the LUT. It will be appreciated that the universal remote control device 300 advantageously can provide an audible or visible alarm in the event that the analysis data does not correspond to a valid LUT index value. During step S42, the correction commands are transmitted to one of the monitors 200a-200n.

A check is then performed at step S44 to determine whether all of the N−1 monitors have been corrected so that all of the monitors 200a-200n generate visually similar images, i.e., the user's eyes are not drawn to a particular one of the monitors 200a-200n. In the determination is negative, the routine jumps to the start of step S36. If the determination is affirmative, the routine ends at step S46.

It should be mentioned at this point that the video camera advantageously can be any imaging device capable of generating a color image that can be subsequently transferred to the universal remote control device 300. For example, the camera 100 need not be an expensive video camera; camera 100 can be a low cost “web cam,” a fixed focus, low resolution camera with a serial or USB output connection designed to connect to a personal computer. Moreover, the camera 100 need not be a video camera. A digital still camera would be equally effective, particularly since most digital still cameras include provisions for downloading one or more images to a computer or similar device. In short, the camera 100 need only be able to generate one of signals or data corresponding to discreet video images generated by each of the N displays.

It should also be mentioned that the universal remote control device 300 advantageously can be a computer or other device which instantiates functions for performing the routines discussed above. It will be noted that laptop computers generally include serial and USB ports; many laptops are capable of producing the IR signals employed in controlling televisions and monitors. In fact, there are several computers commercially available which include a built-in video camera; such computers are designed to support low-resolution video conferencing. Several personal digital assistants (PDAs), e.g., Palm™ and Handspring PDAs can be programmed to generate IR signals for controlling tens of television models. Moreover, the Handspring devices can accept a video camera device for capturing 320×240 or 640×480 pixel images in 16-bit color for use in e-mail and to enhance address books. It will be appreciated that none of these devices possesses the software for converting these general-purpose devices or collections of devices into the universal remote control device 300 described above.

Although presently preferred embodiments of the present invention have been described in detail herein, it should be clearly understood that many variations and/or modifications of the basic inventive concepts herein taught, which may appear to those skilled in the pertinent art, will still fall within the spirit and scope of the present invention, as defined in the appended claims.

What is claimed is:

1. A method for adjusting the display of N display devices generating N respective copies of a video image, comprising:
analyzing video data corresponding to a captured video image representing the video image from a selected one of the N display devices;
determining correction commands applicable to the selected one of the N display devices to convert the captured video image to a desired video image responsive to the video data;
transmitting the correction commands to the selected one of the N display devices to thereby permit the video image generated by the selected one of the N display devices to approximate the desired video image; and
repeating the analyzing, determining, and transmitting steps to thereby approximate the desired video image on all of the N display devices, where N is a positive integer greater than 1.

2. The method as recited in claim 1, further comprising:
receiving the captured video image; and
converting the captured video image to the video data,
where the receiving and converting steps are performed prior to the analyzing step.

3. The method as recited in claim 1, further comprising:
receiving video data corresponding to the captured video image; and
storing the video data;
where the receiving and storing steps are performed prior to the analyzing step.

4. The method as recited in claim 1, wherein the correction commands include color and contrast correction commands.

5. The method as recited in claim 1, wherein the correction commands correspond to signals generated by a remote control device associated with the selected one of the N display devices.

6. The method as recited in claim 1, wherein:
at least one of the N display devices includes an infrared receiver that receives infrared commands from an associated remote control device; and
the transmitting step further comprises transmitting the correction commands as infrared signals to at least one of the N display devices to thereby permit the video image generated by at least one of the N display devices to approximate the desired video image.

7. A method for adjusting the display of N display devices generating N respective copies of a video image, comprising:
storing desired video data representing a desired video image generated by a selected one of the N display devices; and
for the remaining N−1 display devices:
comparing video data corresponding to a captured video image representing the video image from a selected one of the N−1 display devices with the desired video data to thereby generate comparison data;
determining correction commands applicable to the selected one of the N−1 display devices to cause the captured video image to approximate the desired video image responsive to the comparison data; and
transmitting the correction commands to the selected one of the N−1 display devices to thereby permit the video image generated by the selected one of the N−1 display devices to approximate the desired video image,
where N is a positive integer greater than 1.

8. The method as recited in claim 7, further comprising:
receiving the captured video image; and
converting the captured video image to the video data,
where the receiving and converting steps are performed prior to the analyzing step.

9. The method as recited in claim 7, further comprising:
receiving video data corresponding to the captured video image; and
storing the video data;
where the receiving and storing steps are performed prior to the analyzing step.

10. The method as recited in claim 7, wherein the correction commands include color and contrast correction commands.

11. The method as recited in claim 7, wherein the correction commands correspond to signals generated by a remote control device associated with the selected one of the N−1 display devices.

12. The method as recited in claim 7, wherein:
at least one of the N−1 display devices includes an infrared receiver that receives infrared commands from an associated remote control device; and
the transmitting step further comprises transmitting the correction commands as infrared signals to at least one of the N−1 display devices to thereby permit the video image generated by at least one of the N−1 display devices to approximate the desired video image.

13. An apparatus for adjusting the display of N display devices generating N respective copies of a video image, comprising:
means for analyzing video data corresponding to a captured video image representing the video image from a selected one of the N display devices;
means for determining correction commands applicable to the selected one of the N display devices to convert the captured video image to a desired video image responsive to the video data;
means for transmitting the correction commands to the selected one of the N display devices to thereby permit the video image generated by the selected one of the N display devices to approximate the desired video image,
wherein:
the analyzing, determining, and transmitting functions are performed seriatim to adjust for each of the N display devices to thereby generate the desired video image; and
N is a positive integer greater than 1.

14. The apparatus as recited in claim 13, wherein the analyzer means comprises a digital signal processor.

15. The apparatus as recited in claim 13, wherein the determining means comprises a lookup table.

16. The apparatus as recited in claim 13, wherein the correction commands output by the transmitting means correspond to signals generated by a remote control device associated with the selected one of the N display devices.

17. The apparatus as recited in claim 13, wherein:
at least one of the N display devices includes an infrared receiver that receives infrared commands from an associated remote control device; and
the transmitting means transmits the correction commands as infrared signals.

18. An apparatus for adjusting the display of N display devices generating N respective copies of a video image, comprising:
means for storing desired video data representing a desired video image generated by a selected one of the N display devices;
means for comparing video data corresponding to a captured video image representing the video image from a selected one of the N−1 display devices with the desired video data to thereby generate comparison data;
means for determining correction commands applicable to the selected one of the N−1 display devices to cause the captured video image to approximate the desired video image responsive to the comparison data; and
means for transmitting the correction commands to the selected one of the N−1 display devices to thereby permit the video image generated by the selected one of the N−1 display devices to approximate the desired video image,
where N is a positive integer greater than 1.

19. The apparatus as recited in claim 18, wherein the analyzer means comprises a digital signal processor.

20. The apparatus as recited in claim 18, wherein the determining means comprises a lookup table.

21. The apparatus as recited in claim 18, wherein:
at least one of the N display devices includes an infrared receiver that receives infrared commands from an associated remote control device; and
the transmitting means transmits the correction commands as infrared signals to the at least one of the N display devices.

22. A universal remote control device for adjusting the display of N display devices generating N respective copies of a video image, comprising:
an analyzer that analyzes video data corresponding to a captured video image representing the video image from a selected one of the N display devices with respect to predetermined video data and generates correction data;
a processor that generates correction commands applicable to the selected one of the N display devices to convert the captured video image to a desired video image responsive to the video data responsive to the correction data; and
a transmitter that outputs the correction commands to the selected one of the N display devices to thereby permit the video image generated by the selected one of the N display devices to approximate the desired video image,
where N is a positive integer greater than 1.

23. The universal remote control device as recited in claim 22, further comprising:
an input circuit which receives the captured video image; and
a converter producing the video data from the captured video image.

24. The universal remote control device as recited in claim 22, further comprising:
an input device that receives video data corresponding to the captured video image;
a memory that stores the video data.

25. The universal remote control device as recited in claim 22, wherein the correction commands output by the transmitter correspond to signals generated by a remote control device associated with the selected one of the N display devices.

26. A universal remote control device for adjusting the display of N display devices generating N respective copies of a video image, comprising:
a memory that stores desired video data representing a desired video image generated by a designated one of the N display devices;
a comparator that compares video data corresponding to a captured video image representing the video image from a selected one of the N−1 display devices with the desired video data to thereby generate comparison data;
a converter that outputs correction commands applicable to the selected one of the N−1 display devices to cause the captured video image to approximate the desired video image responsive to the comparison data; and
a transmitter that outputs the correction commands to the selected one of the N−1 display devices to thereby permit the video image generated by the selected one of the N−1 display devices to approximate the desired video image,
where N is a positive integer greater than 1.

27. The universal remote control device as recited in claim 26, wherein the converter comprises a lookup table.

28. A memory storing instructions causing a processor to instantiate functions by which an apparatus including the processor and an output device coupled to the processor:
analyzes video data corresponding to a captured video image representing the video image from a selected one of N display devices;
determines correction commands applicable to the selected one of the N display devices to convert the captured video image to a desired video image responsive to the video data; and
transmits the correction commands to the selected one of the N display devices to thereby permit the video image generated by the selected one of the N display devices to approximate the desired video image,
for each of the N display devices, where N is a positive integer greater than 1.

29. A memory storing instructions causing a processor to instantiate functions by which an apparatus including the processor and an output device coupled to the processor:
stores desired video data representing a desired video image generated by a selected one of N display devices; and
for the remaining N−1 display devices:
compares video data corresponding to a captured video image representing the video image from a selected one of the N−1 display devices with the desired video data to thereby generate comparison data;
determines correction commands applicable to the selected one of the N−1 display devices to cause the captured video image to approximate the desired video image responsive to the comparison data; and
transmits the correction commands to the selected one of the N−1 display devices to thereby permit the video image generated by the selected one of the N−1 display devices to approximate the desired video image,
where N is a positive integer greater than 1.
